(19) United States
(12) Patent Application Publication
(10) Pub. No.: US 2003/0105237 A1
(43) Pub. Date: Jun. 5, 2003

(54) POLYOLEFIN MOLDING COMPOSITION HAVING A BROAD MELTING RANGE, PROCESS FOR ITS PREPARATION, AND ITS USE

(76) Inventors: ANDREAS WINTER, GLASHUETTEN (DE); WALTER SPALECK, LIEDERBACH (DE); BERND BACHMANN, EPPSTEIN (DE)

Correspondence Address: CONNOLLY BOVE LODGE & HUTZ, LLP, 1220 N MARKET STREET, P O BOX 2207, WILMINGTON, DE, 19899

(21) Appl. No.: 08/120,105

(22) Filed: Sep. 10, 1993

(30) Foreign Application Priority Data
Sep. 12, 1992 (DE) P 42 30 530.6

(51) Int. Cl. C08L 23/00

(52) U.S. Cl. 525/240; 525/322; 525/323; 526/351; 526/943

(57) ABSTRACT

Polyolefin molding composition having a broad melting range, process for its preparation, and its use

Polyolefin molding compositions which have a broad, bimodal or multimodal melting range in the DSC spectrum, where the melting range maximum is between 120 and 165° C., are obtained by polymerization or copolymerization of at least two olefins to give polyolefins of different melting point. The olefins have the formula R^{a}CH═CHR^{b}, and the catalyst system comprises an aluminoxane and at least two transition-metal components of the formula I

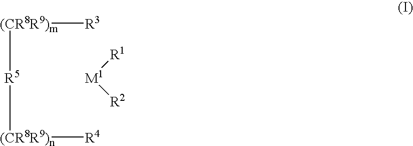

in which

M¹ is Zr, Hf or Ti.

As a rule, metallocene/aluminoxane catalyst systems allow the preparation of polyolefins or polyolefin copolymers having a sharp melting point. These products are highly suitable, for example, for thin-wall injection molding or precision injection molding, giving very short cycle times per injection-molded part.

By contrast, many applications, for example thermo-forming, blow molding, extrusion, injection stretch blow molding and certain film applications are unsuitable for a polyolefin having such a sharp melting and crystallization range.

In thermoforming, a product of this type leads to process problems and, for example, moldings having uneven wall thicknesses. In film applications, heat-sealing or stretching, for example, is difficult with a product having a sharp melting point. Such applications require a polyolefin having a broad melting range.

The object was to find a process which enables the preparation of polyolefin molding compositions having a broad melting range. The object has been achieved by polymerization or copolymerization of the olefin or olefins by means of at least two different metallocenes.

At a certain polymerization temperature, a polyolefin having a certain melting point is formed due to the stereospecificity of each type of metallocene catalyst. Surprisingly, it has now been found that a mixture of at least two metallocenes each of which gives polyolefins of very different melting points give a polyolefin mixture which does not, as expected, have a mixed melting point or a melting point below the melting point of the lower-melting component, but instead gives a polymer product which has two melting points. The melting range determined by means of the DSC (“differential scanning calorimeter”) spectrum is, in direct comparison with the separate polymers, significantly broadened or even bimodal, and the product has the above-discussed advantages on conversion into moldings.

In addition it has been found that the mixing of polyolefins having different melting points, for example by extrusion, likewise gives a product which has a broad bimodal or multimodal melting range.

The invention thus relates to the preparation of a polyolefin molding composition having the following properties:

The molding composition has a broad, bimodal or multi-modal melting range in the DSC spectrum. The melting range maximum is between 120 and 165° C., the half-intensity width of the melting peak is broader than 10° C., and the width determined at the quarter peak height is greater than 15° C. In addition, the half-intensity width of the crystallization peak is greater than 4° C. and the width of the crystallization peak determined at the quarter peak height is greater than 6° C.

Fractional crystallization or extraction with hydro-carbons allows the molding composition to be separated into its components, and the resultant polyolefin components have relatively sharp melting and crystallization peaks.

In addition to the polyolefin, the molding composition according to the invention may also contain conventional additives, for example nucleating agents, stabilizers, antioxidants, UV absorbers, light stabilizers, metal deactivators, free-radical scavengers, fillers and reinforcing agents, compatibilizers, plasticizers, lubricants, emulsifiers, pigments, optical brighteners, flameproofing agents, antistatics and blowing agents.

This novel polyolefin molding composition is prepared

a) by mixing at least two, preferably two or three, polyolefins of different melting points. The melting points of at least two of the polyolefins must differ by at least 5° C. There are no restrictions on the mixing ratio of the polyolefins nor on the molecular weight dispersity. The viscosity index should be greater than VI=10 cm³/g, and the molecular weight M_{w} should be greater than 5000 g/mol. The polymers can be mixed by one of the methods conventional in plastics processing. One possibility is sintering in a high-speed mixer if the polymers to be mixed are pulverulent, and another possibility is the use of an extruder having mixing and compounding elements on the screw, or the use of a compounder as used in the rubber industry, or

b) by direct polymerization of at least two, preferably two or three, polyolefins of different melting point. The melting points of at least two of the polyolefins must differ by at least 5° C. There are no restrictions on the mixing ratio of the polyolefins prepared in the polymerization.

This direct polymerization of the polyolefin molding composition according to the invention is carried out by polymerization or copolymerization of olefins of the formula R^{a}CH═CHR^{b}, in which R^{a} and R^{b} are identical or different and are a hydrogen atom or an alkyl radical having 1 to 14 carbon atoms, or R^{a} and R^{b}, together with the atoms connecting them, can form a ring, at a temperature of from −60 to 200° C., a pressure of from 0.5 to 100 bar, in solution, in suspension or in the gas phase, in the presence of a catalyst which comprises at least two transition-metal components (metallocenes) and an aluminoxane of the formula II

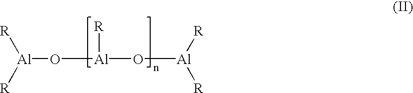

for the linear type and/or of the formula III

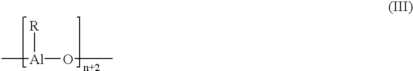

for the cyclic type, where, in the formulae II and III, the radicals R may be identical or different and are a C₁-C₆-alkyl group, a C₁-C₆-fluoroalkyl group, a C₆-C₁₈-aryl group, a C₆-C₁₈-fluoroaryl group or hydrogen, and n is an integer from 0 to 50, and the aluminoxane component may additionally contain a compound of the formula AlR₃,

where the transition-metal component used comprises at least two metallocenes of the formula I:

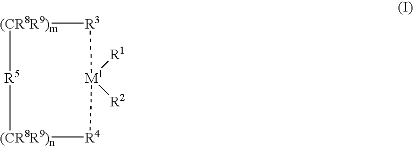

in which

M¹ is Zr, Hf or Ti,

R¹ and R² are identical or different and are a hydrogen atom, a C₁-C₁₀-alkyl group, a C₁-C₁₀-alkoxy group, a C₆-C₁₀-aryl group, a C₆-C₁₀-aryloxy group, a C₂-C₁₀-alkenyl group, a C₇-C₄₀-arylalkyl group, a C₇-C₄₀-alkylaryl group, a C₈-C₄₀-arylalkenyl group or a halogen atom,

R³ and R⁴ are identical or different and are a monocyclic or polycyclic, unsubstituted or substituted hydrocarbon radical which, together with the metal atom M¹, can form a sandwich structure,

R⁵ is

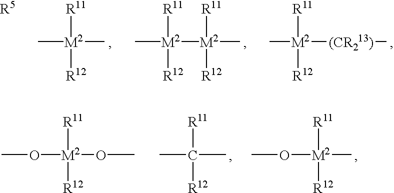

═BR¹¹, ═AlR¹¹, —Ge—, —Sn—, —O—, —S—, ═SO, ═SO₂, ═NR¹¹, ═CO, ═PR¹¹ or ═P(O)R¹¹,

where

R¹¹, R¹² and R¹³ are identical or different and are a hydrogen atom, a halogen atom, a C₁-C₁₀-alkyl group, a C₁-C₁₀-fluoroalkyl group, a C₆-C₁₀-aryl group, a C₆-C₁₀-fluoroaryl group, a C₁-C₁₀-alkoxy group, a C₂-C₁₀-alkenyl group, a C₇-C₄₀-arylalkyl group, a C₈-C₄₀-arylalkenyl group or a C₇-C₄₀-alkylaryl group, or R¹¹ and R¹² or R¹¹ and R¹³, in each case together with the atoms connecting them, form a ring, and M² is silicon, germanium or tin,

R⁸ and R⁹ are identical or different and are as defined for R¹¹,

m and n are identical or different and are zero, 1 or 2, where m plus n is zero, 1 or 2.

Alkyl is straight-chain or branched alkyl. Halogen (halogenated) denotes fluorine, chlorine, bromine or iodine, preferably fluorine or chlorine.

M¹ is Zr, Hf or Ti, preferably Zr or Hf.

R¹ and R² are identical or different and are a hydrogen atom, a C₁-C₁₀-, preferably C₁-C₃-alkyl group, a C₁-C₁₀-, preferably C₁-C₃-alkoxy group, a C₆-C₁₀-, preferably C₆-C₈-aryl group, a C₆-C₁₀-, preferably C₆-C₈-aryloxy group, a C₂-C₁₀-, preferably C₂-C₄-alkenyl group, a C₇-C₄₀-, preferably C₇-C₁₀-arylalkyl group, a C₇-C₄₀-, preferably C₇-C₁₂-arylalkyl group, a C₈-C₄₀-, preferably C₈-C₁₂-arylalkenyl group or a halogen atom, preferably chlorine.

R³ and R⁴ are identical or different monocyclic or polycyclic, unsubstituted or substituted hydrocarbon radicals which, together with the metal atom M¹, can form a sandwich structure.

R⁵ is

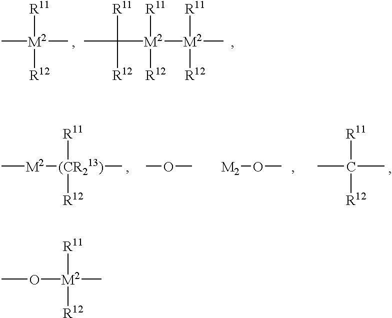

═BR¹¹, ═AlR¹¹, —Ge—, —Sn—, —O—, —S—, ═SO, ═SO₂, ═NR¹¹, ═CO, ═PR¹¹ or ═P(O)R¹¹, where R¹¹, R¹², and R¹³ are identical or different and are a hydrogen atom, a halogen atom, a C₁-C₁₀-, preferably C₁-C₄-alkyl group, in particular a methyl group, a C₁-C₁₀-fluoroalkyl group, preferably a CF₃ group, a C₆-C₁₀-, preferably C₆-C₈-aryl group, a C₆-C₁₀-fluoroaryl group, preferably a pentafluorophenyl group, a C₁-C₁₀-, preferably C₁-C₄-alkoxy group, in particular a methoxy group, a C₂-C₁₀-, preferably C₂-C₄-alkenyl group, a C₇-C₄₀-, preferably C₇-C₁₀-arylalkyl group, a C₈-C₄₀-, preferably C₈-C₁₂-arylalkenyl group or a C₇-C₄₀-, preferably C₇-C₁₂-alkylaryl group, or R¹¹ and R¹² or R¹¹ and R¹³, in each case together with the atoms connecting them, form a ring.

M² is silicon, germanium or tin, preferably silicon or germanium.

R⁵ is preferably ═CR¹¹R¹², ═SiR¹¹R¹², ═GeR¹¹R¹², —O—, —S—, ═SO, ═PR¹¹ or ═P(O)R¹¹.

R⁶ and R⁹ are identical or different and are as defined for R¹¹.

m and n are identical or different and are zero, 1 or 2, preferably zero or 1, where m plus n is zero, 1 or 2, preferably zero or 1.

Particularly preferred metallocenes are thus those in which M¹ is zirconium or hafnium, R¹ and R² are identical and are methyl or chlorine, R⁴ and R³ are indenyl, cyclopentadienyl or fluorenyl, where these ligands may carry additional substituents as defined for R¹¹, R¹² and R¹³, where the substituents may be different and, with the atoms connecting them, may also form rings, R⁵ is a

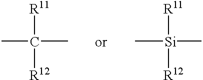

radical, and n plus m is zero or 1, in particular the compounds listed in the working examples.

The chiral metallocenes are employed as a racemate for the preparation of highly isotactic polyolefins. However, the pure R or S form can also be used. These pure stereoisomeric forms can be used to prepare an optically active polymer. However, the meso form of the metallocenes can be separated off, since the polymerization-active center (the metal atom) in these compounds is no longer chiral due to mirror symmetry at the central metal and a highly isotactic polymer therefore cannot be produced. If the meso form is not separated off, atactic polymer is formed in addition to isotactic polymer. For certain applications—soft moldings for example—this may be entirely desirable. Metallocenes having a formal C_{S} symmetry are suitable for the preparation of syndiotactic polyolefins.

The separation of the stereoisomers is known in principle.

In principle, the metallocenes I can be prepared by the following reaction scheme:

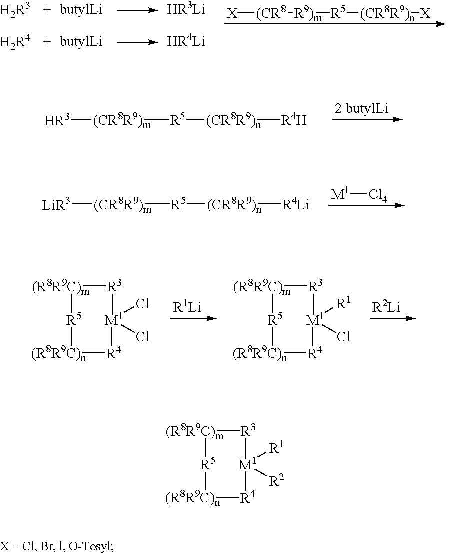

The preparation of the metallocene compounds is known.

The DSC measurements on the polyolefin composition according to the invention are preferably carried out at a heating or cooling rate of ≦20° C./min.

The choice of metallocenes for the polymerization of olefins to give polyolefins having a broad, bimodal or multimodal melting range can in each case take place by means of a test polymerization per metallocene.

In this test, the olefin is polymerized to the polyolefin and its melting curve determined by DSC analysis. The metallocenes are then combined depending on the desired melting range with respect to melting range maximum and melting range width.

Taking into account the polymerization activities, computer simulation of the combined DSC curves makes it possible to adjust each desired melting curve type via the type of metallocenes and via the mixing ratio of the metallocenes with one another.

The number of metallocenes I to be used according to the invention in the polymerization is preferably 2 or 3, in particular 2. However, it is also possible to employ a larger number (such as, for example, 4 or 5) in any desired combination.

Taking into account the polymerization activities and molecular weights at various polymerization temperatures, in the presence of hydrogen as molecular weight regulator or in the presence of comonomers, the computer simulation model can be further refined and the applicability of the process according to the invention further improved.

The cocatalyst used is an aluminoxane of the formula II and/or III, in which n is an integer from 0 to 50, preferably from 10 to 35.

The radicals R are preferably identical and are methyl, isobutyl, phenyl or benzyl, particularly preferably methyl.

If the radicals R are different, they are preferably methyl and hydrogen or alternatively methyl and isobutyl, where hydrogen or isobutyl is preferably present to the extent of 0.01-40% (number of radicals R). Instead of the aluminoxane, the cocatalyst used in the polymerization can be a mixture comprising the aluminoxane and AlR₃, where R is as defined above.

The aluminoxane can be prepared in various ways by known processes. One of the methods is, for example, to react an aluminum hydrocarbon compound and/or a hydridoaluminum hydrocarbon compound with water (in gas, solid, liquid or bonded form, for example as water of crystallization) in an inert solvent (such as, for example, toluene). In order to prepare an aluminoxane containing different alkyl groups R, two different trialkylaluminum compounds (AlR₃+AlR′₃) in accordance with the desired composition are reacted with water (cf. S. Pasynkiewicz, Polyhedron 9 (1990) 429 and EP-A 302 424).

The precise structure of the aluminoxanes II and III is unknown.

Depending on the type of preparation, all aluminoxane solutions have in common a varying content of unreacted aluminum starting compound, which is in free form or as an adduct.

It is possible to preactivate the metallocenes before use in the polymerization reaction, in each case separately or together as a mixture with an aluminoxane of the formula (II) and/or (III). This significantly increases the polymerization activity and improves the grain morphology.

The preactivation of the metallocenes is carried out in solution. The metallocenes are preferably dissolved, as a solid, in a solution of the aluminoxane in an inert hydrocarbon. Suitable inert hydrocarbons are aliphatic and aromatic hydrocarbons. Preference is given to toluene or a C₆-C₁₀-hydrocarbon.

The concentration of the aluminoxane in the solution is in the range from about 1% by weight to the saturation limit, preferably from 5 to 30% by weight, in each case based on the total solution. The metallocenes can be employed in the same concentration, but are preferably employed in an amount of from 10⁻⁴ to 1 mol per mol of aluminoxane. The preactivation time is from 5 minutes to 60 hours, preferably from 5 to 60 minutes. The temperature is from −78 to 100° C., preferably from 0 to 70° C.

The metallocenes can also be prepolymerized or applied to a support. For prepolymerization, the (or one of the) olefin(s) employed in the polymerization is preferably used.

Examples of suitable supports are silica gels, aluminum oxides, solid aluminoxane, combinations of aluminoxane on a support, such as, for example, silica gel or other inorganic support materials. Another suitable support material is a polyolefin powder in finely divided form.

A further possible embodiment of the process according to the invention comprises using a salt-like compound of the formula RₓNH₄₋ₓBR′₄ or of the formula R₃PHBR′₄ as cocatalyst in place of or in addition to an aluminoxane. In these formulae, x is 1, 2 or 3, R is identical or different and is alkyl or aryl, and R′ is aryl, which may also be fluorinated or partly fluorinated. In this case, the catalyst comprises the product of the reaction of the metallocenes with one of said compounds (cf. EP-A 277 004).

In order to remove catalyst poisons present in the olefin, purification by means of an alkylaluminum compound, for example AlMe₃ or AlEt₃, is advantageous. This purification can be carried out either in the polymerization system itself, or the olefin is brought into contact with the Al compound before addition to the polymerization system and subsequently removed again.

The polymerization or copolymerization is carried out in a known manner in solution, in suspension or in the gas phase, continuously or batchwise, in one or more steps, at a temperature of from −60 to 200° C., preferably from 20 to 80° C. Olefins of the formula R^{a}—CH═CH—R^{b} are polymerized or copolymerized. In this formula, R^{a} and R^{b} are identical or different and are a hydrogen atom or an alkyl radical having 1 to 14 carbon atoms. However, R^{a} and R^{b} may also form a ring together with the carbon atoms connecting them. Examples of such olefins are ethylene, propylene, 1-butene, 1-hexene, 4-methyl-1-pentene, 1-octene, norbornene and norbornadiene. In particular, propylene and ethylene are polymerized.

If necessary, hydrogen is added as molecular weight regulator.

The total pressure in the polymerization system is from 0.5 to 100 bar. The polymerization is preferably carried out in the industrially particularly relevant pressure range of from 5 to 64 bar.

The metallocenes are used in a concentration, based on the transition metal, of from 10⁻³ to 10⁻⁸ mol, preferably from 10⁻⁴ to 10⁻⁷ mol, of transition metal per dm³ of solvent or per dm³ of reactor volume. The aluminoxane or the aluminoxane/AlR₃ mixture is used in a concentration of from 10⁻⁵ to 10⁻¹ mol, preferably from 10⁻⁴ to 10⁻² mol, per dm³ of solvent or per dm³ of reactor volume. In principle, however, higher concentrations are also possible.

If the polymerization is carried out as a suspension or solution polymerization, an inert solvent which is customary for the Ziegler low-pressure process is used. For example, the polymerization is carried out in an aliphatic or cycloaliphatic hydrocarbon, examples which may be mentioned being butane, pentane, hexane, heptane, decane, isooctane, cyclohexane and methylcyclohexane.

It is furthermore possible to use a benzine or hydrogenated diesel oil fraction. Toluene can also be used. The polymerization is preferably carried out in the liquid monomer.

If inert solvents are used, the monomers are metered in as gases or liquids.

The polymerization can have any desired duration, since the catalyst system to be used according to the invention exhibits only a slight time-dependent drop in polymerization activity.

The process according to the invention is distinguished by the fact that the metallocenes described give polymers having a broad, bimodal or multimodal melting range in the industrially relevant temperature range of between 20 and 80° C. and with high polymerization activity.

The polyolefin molding compositions according to the invention are particularly suitable for the production of moldings by thermoforming, blow molding, extrusion, injection stretch blow molding and for certain film applications, such as heat-sealing or stretching.

The examples below serve to illustrate the invention in greater detail.

The following abbreviations are used:

$$\begin{matrix}V I = viscosity index in {cm}^{3} \text{/} g \\ {M}_{w} = weight average molecular weight in g \text{/} mol \\ {M}_{w} / {M}_{n} = molecular weight dispersity )\end{matrix} \} \qquad \begin{matrix}determined by \\ gel permeation \\ chromatography\end{matrix}$$

MFI (230/5)=melt flow index, measured according to DIN 53735, at a melt temperature of 230° C. and with a weight of 5 kg.

Melting points, peak widths, melting ranges and crystallization temperatures were determined by DSC spectrometry (heating/cooling rate 20° C./min).

### EXAMPLE 1

In each case 5 kg of two different polypropylene powders were mixed, stabilized against chemical degradation under extrusion conditions by means of 20 g of pentaerythrityl tetrakis [3-(3,5-di-t-butyl-4-hydroxyphenyl)propionate], extruded in a ZSK 28 twin-screw extruder (Werner und Pfleiderer) and subsequently granulated. The temperatures in the heating zones were 150° C. (feed), 210° C., 250° C., 280° C. and 215° C. (die plate), the material temperature in the extruder was 275° C., and the extruder screws rotated at 250 rpm. The base polymers used for the mixture had the following properties:

Polymer 1: VI=255 cm³/g; MFI (230/5)=6.8 dg/min; M_{w}=310,000 g/mol; M_{w}/Mₙ=2.2; melting point (melting peak maximum) 139° C., half-intensity width of the melting peak 5° C., width at quarter peak height 16° C.; crystallization point 101° C., half-intensity width of the crystallization peak 4.0° C., width at quarter peak height 5.5° C.

Polymer 2: VI=235 cm³/g; MFI (230/5)=10 dg/min; M_{w}=277,000 g/mol; M_{w}/Mₙ=2.3; melting point (melting peak maximum) 152° C., half-intensity width of the melting peak 8° C., width at quarter peak height 12° C.; crystallization point 105° C., half-intensity width of the crystallization peak 6° C., width at quarter peak height 7.5° C.

The novel molding composition prepared by extrusion had the following data:

VI=257 cm³/g; MFI (230/5)=8.7 dg/min; M_{w}=300,000 g/mol; M_{w}/Mₙ=2.8; melting range maximum at 150° C., shoulder at 130° C.; half-intensity width of the melting peak 19° C., width at quarter peak height 31° C.; crystallization peak maximum 105° C.; half-intensity width of crystallization peak 8.5° C., width at quarter peak height 11.5° C.

### EXAMPLE 2

Example 1 was repeated, but two other polypropylene components were used and the extruder parameters were 130° C. (feed), 155° C., 200° C., 250° C. and 250° C. (die plate), material temperature 225° C., extruder screw speed 300 rpm.

Polymer 1: VI=155 cm³/g; MFI (230/5)=65 dg/min; M_{w}=172,000 g/mol; M_{w}/Mₙ=2.8; melting point (melting peak maximum) 137° C., half-intensity width of the melting peak 10° C., width at quarter peak height 17° C.; crystallization point 104° C., half-intensity width of the crystallization peak 5° C., width at quarter peak height 7.5° C.

Polymer 2: VI=156 cm³/g; MFT (230/5)=68 dg/min; M_{w}=153,500 g/mol; M_{w}/Mₙ=2.1; melting point (melting peak maximum) 153° C., half-intensity width of the melting peak 7.5° C., width at quarter peak height 18.8° C.; crystallization point 110° C., half-intensity width of the crystallization peak 5° C., width at quarter peak height 7.5° C.

Novel molding composition prepared therefrom:

VI=158 cm³/g; MFI (230/5)=67 dg/min; M_{w}=168,000 g/mol; M_{w}/Mₙ=2.6; melting range maximum at 148° C., shoulder at 138° C.; half-intensity width 19° C., width at quarter peak height 31° C.; crystallization peak maximum 112° C.; half-intensity width of crystallization peak 6° C., width at quarter peak height 10.5° C.

### EXAMPLE 3

Example 1 was repeated, but two other polypropylene components were used and the extruder parameters were 150° C. (feed), 160° C., 240° C., 240° C. and 240° C. (die plate), material temperature 250° C., extruder screw speed 220 rpm.

Polymer 1: VI=407 cm³/g; MFI (230/5)=1.9 dg/min; M_{w}=488,000 g/mol; M_{w}/Mₙ=2.2; melting point (melting peak maximum) 158° C., half-intensity width of the melting peak 8° C., width at quarter peak height 15° C.; crystallization point 109° C., half-intensity width of the crystallization peak 6.5° C., width at quarter peak height 9.5° C.

Polymer 2: VI=132 cm³/g; MFI (230/5)=93 dg/min; melting point (melting peak maximum) 138° C., half-intensity width of the melting peak 7° C., width at quarter peak height 18° C.; crystallization peak (maximum) 99° C., half-intensity width of the crystallization peak 6.5° C., width at quarter peak height 8° C.

Novel molding composition prepared therefrom:

VI=247 cm³/g; MFI (230/5)=12.3 dg/min; M_{w}=268,000 g/mol; M_{w}/Mₙ=3.0; melting range maximum at 154° C., shoulder at 141° C.; half-intensity width 15° C., width at quarter peak height 29° C.; crystallization at 114° C.

### EXAMPLE 4

Example 3 was repeated, but the polymer component 2 used therein was replaced by a polypropylene having the following data:

VI=353 cm³/g; MFI (230/5)=2.1 dg/min; M_{w}=465,500 g/mol; M_{w}/Mₙ=2.1; melting point (melting peak maximum) 153° C., half-intensity width of the melting peak 9.5° C., width at quarter peak height 13.5° C.; crystallization point 110° C., half-intensity width of the crystallization peak 7.5° C., width at quarter peak height 9° C.

Novel molding composition prepared therefrom:

VI=366 cm³/g; MFI (230/5) 1.9 dg/min; M_{w}=486,500 g/mol; M_{w}/Mₙ=2.1; double melting range maximum at 157 and 159° C., half-intensity width 17.5° C., width at quarter peak height 29° C.; crystallization at 115° C., width at quarter peak height 11° C.

### EXAMPLE 5

The procedure was as in Example 1, but 5 kg of polymer 1 from Example 3 and 10 kg of polymer 1 from Example 1 were used. The extruder parameters were 150° C. (feed), 160° C., 250° C., 250° C. and 240° C. (die plate), material temperature 255° C., extruder screw speed 190 rpm.

The novel molding composition prepared from these two polymer components had the following data:

VI=302 cm³/g; MFI (230/5)=4.2 dg/min; M_{w}=366,500 g/mol; M_{w}/Mₙ=2.5; melting range maximum 151° C., half-intensity width 18° C., width at quarter peak height 34.5° C., crystallization at 106° C. with a signal half-intensity width of 7.5° C. and a width at quarter peak height of 10.5° C.

### EXAMPLE6

A dry 150 dm³ reactor was flushed with propylene and charged at 20° C. with 80 dm³ of a benzine fraction having the boiling range 100-120° C. from which the aromatic components had been removed, 50 dm³ of liquid propylene and 150 cm³ of a toluene solution of methylaluminoxane (corresponding to 250 mmol of Al, molecular weight according to hygroscopic determination 1050 g/mol). The temperature was then adjusted to 40° C. A hydrogen content of 0.05% by volume was set in the gas phase (the content was kept constant during the polymerization by continual topping up of hydrogen). 7.5 mg of a rac-Me₂Si(2-methyl-1-indenyl)₂ZrCl₂ and 45 mg of a rac-Me₂Si(indenyl)₂HfCl₂ were mixed, and the solid was dissolved in 25 cm³ of a toluene solution of methylaluminoxane (42 mmol of Al) and introduced into the reactor after 15 minutes. The polymerization system was kept at 43° C. for 24 hours by cooling. Polymerization was terminated by addition of 2.5 bar of CO₂ gas and the polymer formed (22.6 kg) was separated from the suspension medium in a pressure filter. The product was dried for 24 hours at 80° C./200 mbar. 50 g of pentaerythrityl tetrakis[3-(3,5-di-t-butyl-4-hydroxyphenyl)propionate] were added to the polymer powder to prevent chemical degradation, and the mixture was extruded in a ZSK 28 twin-screw extruder (Werner und Pfleiderer) and then granulated. The temperatures in the heating zones were 150° C. (feed), 200° C., 240° C., 250° C. (die plate), the extruder screw speed was 200 rpm, and the material temperature was 250° C.

The novel molding composition had the following data:

VI=285 cm³/g; MFI (230/5)=5.4 dg/min; M_{w}=334,500 g/mol; M_{w}/Mₙ=2.2; melting range maximum at 152° C., shoulder at 132° C., half-intensity width of the melting peak 17.5° C., width at quarter peak height 35° C.; crystallization peak maximum 106° C.; half-intensity width of crystallization peak 8.5° C.; width at quarter peak height 12.5° C.

### EXAMPLE 7

Example 6 was repeated, but the metallocenes used were 7.5 mg of phenyl(methyl)Si(2-methyl-1-indenyl)₂ZrCl₂ and 2.5 mg of Me₂Si(2-methyl-4-phenyl-1-indenyl)₂ZrCl₂, the polymerization temperature was 48° C. and a hydrogen content of 2.5% by volume was set in the gas phase. 21.5 kg of polymer were obtained. The molding composition obtained after extrusion and granulation had the following properties:

VI=194 cm³/g; MFI (230/5)=28.8 dg/min; M_{w}=238,000 g/mol; M_{w}/Mₙ=2.8; melting range maximum at 157° C., half-intensity width 13.5° C., width at quarter peak height 24° C.; crystallization peak maximum 115° C.; half-intensity width 6.5° C.; width at quarter peak height 9.5° C.

The molding composition was separated into two constituents semi-quantitatively by fractional crystallization.

Polymer 1 made up about 45% by weight and had the following data:

VI=179 cm³/g; MFI (230/5)=34 dg/min; M_{w}=195,000 g/mol; M_{w}/Mₙ=2.1; melting point (melting peak maximum) 151° C., half-intensity width 8.5° C., crystallization peak 111° C.; half-intensity width 4° C.

Polymer 2 made up about 55% by weight and had the following data:

VI=207 cm³/g; MFI (230/5)=27 dg/min; M_{w}=259,000 g/mol; M_{w}/Mₙ=2.5; melting point (melting peak maximum) 159° C., half-intensity width 5° C., width at quarter peak height 12.5° C.; crystallization peak at 117° C.; half-intensity width 2.5° C. and width at quarter peak height 5° C.

### EXAMPLE 8

Example 6 was repeated, but the polymerization temperature was 50° C., the hydrogen content in the gas space was 2.5% by volume and the metallocenes used were 2.5 mg of Me₂Si (2-methyl-4-phenyl-1-indenyl)₂ZrCl₂ and 95 mg of phenyl(methyl)silyl(indenyl)₂HfCl₂. 18.5 kg of polymer were obtained. The extruded molding composition had the following data:

VI=166 cm³/g; MFI (230/5)=45.8 dg/min; M_{w}=232,000 g/mol; M_{w}/Mₙ=3.3; melting range maximum at 156° C., shoulder at 140° C., half-intensity width 13° C., width at quarter peak height 30° C.; crystallization peak maximum 115° C., width at quarter peak height 8° C.

The molding composition was separated into two constituents semi-quantitatively by fractional crystallization.

Polymer 1 made up about 60% by weight and had the following properties:

VI=132 cm³/g; MFI (230/5)=98 dg/min; M_{w}=146,000 g/mol; M_{w}/Mₙ=2.2; melting point 137° C., half-intensity width 7.5° C.; crystallization peak 99° C.; half-intensity width 6.5° C.

Polymer 2 made up about 40% by weight and had the following data:

VI=227 cm³/g; MFI (230/5)=23 dg/min; M_{w}=265,500 g/mol; M_{w}/Mₙ=2.0; melting point 160° C., half-intensity width 5.5° C., width at quarter peak height 6° C.; crystallization peak 118° C.; half-intensity width 3.5° C., width at quarter peak height 5° C.

### EXAMPLE 9

Example 6 was repeated, but the polymerization temperature was 50° C., the hydrogen content of the gas space was 1.2% by volume and the metallocenes used were 7.5 mg of Me₂Si(2-methyl-1-indenyl)₂ZrCl₂ and 80 mg of Me₂Si(indenyl)₂HfCl₂. 22.5 kg of polymer were obtained, and the extruded molding composition had the following data:

VI=130 cm³/g; MFI (230/5)=110 dg/min; M_{w}=142,500 g/mol; M_{w}/Mₙ=2.0; melting range maximum 149.5° C., shoulder at 137° C., half-intensity width 15.5° C., width at quarter peak height 27.5° C.; crystallization peak maximum 112° C., half-intensity width 7.5° C.

The molding composition was separated semi-quantitatively into two different constituents in a ratio of about 50:50% by weight by fractional crystallization. Of these, polymer 1 had the following data:

VI=130 cm³/g; MFI (230/5)=114 dg/min; M_{w}=135,000 g/mol; M_{w}/Mₙ=1.9; melting point 151° C., half-intensity width 8.5° C.; crystallization peak 109° C.; half-intensity width 5.5° C.

Polymer 2 is characterized as follows:

VI=136 cm³/g; MFI (230/5)=100 dg/min; M_{w}=142,000 g/mol; M_{w}/Mₙ=2.2; melting point 135° C., half-intensity width 7° C.; crystallization peak 97° C.; half-intensity width 6.5° C.

### EXAMPLE 10

The procedure was as in Example 7, but the ratio between the two metallocenes used was changed from 7.5 mg/2.5 mg to 10.4 mg/1.8 mg.

The molding composition obtained after extrusion had the following properties:

VI=192 cm³/g; MFI (230/5)=30.4 dg/min; M_{w}=241,500 g/mol; M_{w}/Mₙ=2.3; melting range maximum at 155° C., half-intensity width 12° C., width at quarter peak height 22.5° C.; crystallization at 113° C.

### EXAMPLE 11

The procedure was as in Example 7, but the ratio between the two metallocenes used was changed from 7.5 mg/2.5 mg to 3.9 mg/5.2 mg.

The molding composition obtained after extrusion had the following properties:

VI=197 cm³/g; MFI (230/5)=28.9 dg/min; M_{w}=214,000 g/mol; M_{w}/Mₙ=2.5; melting range maximum at 158° C., width at quarter peak height 24° C.; crystallization at 116° C.

### EXAMPLE 12

The procedure was as in Example 8, but the ratio between the two metallocenes used was changed from 2.5 mg/95 mg to 1.5 mg/125 mg.

The molding composition examined after extrusion had the following properties:

VI=162 cm³/g; MFI (230/5)=62 dg/min; M_{w}=198,000 g/mol; M_{w}/Mₙ=2.7; melting range maximum at 151° C., shoulder at 135° C., half-intensity width 16° C., width at quarter peak height 32.5° C.; crystallization at 114° C.

### EXAMPLE 13

The procedure was as in Example 8, but the ratio between the two metallocenes used was changed from 2.5 mg/95 mg to 3.6 mg/51.5 mg.

The molding composition examined after extrusion had the following properties:

VI=187 cm³/g; MFI (230/5)=37.1 dg/min; M_{w}=209,500 g/mol; M_{w}/Mₙ=2.9; melting range maximum at 157° C., width at quarter peak height 27.5° C.; crystallization at 116° C.

### EXAMPLE 14

A dry 24 dm³ reactor was flushed with propylene and charged with 10 dm³ (S.T.P.) of hydrogen, 12 dm³ of liquid propylene and 32 cm³ of a toluene solution of methyl-aluminoxane (corresponding to 52 mmol of Al, mean degree of oligomerization n=21). The contents were stirred at 30° C. for 15 minutes at 250 rpm.

In parallel, 6.2 mg of rac-ethylene(2-methyl-1-indenyl)₂ZrCl₂ and 1.0 mg of rac-Me₂Si(2-methyl-4-phenyl-1-indenyl)₂ZrCl₂ were dissolved in 12 cm³ of a toluene solution of methylaluminoxane (20 mmol of Al) and pre-activated by standing for 15 minutes. The solution was introduced into the reactor, and the mixture was polymerized at 60° C. for 1 hour. 2.05 kg of polypropylene were obtained. The molding composition prepared by extrusion had the following data:

VI=285 cm³/g; MFI (230/5)=7.5 dg/min; M_{w}=395,000 g/mol; M_{w}/Mₙ=3.3; melting range maximum 159° C., shoulder at 151° C., half-intensity width 14° C., width at quarter peak height 30.5° C.; crystallization at 116° C.

### EXAMPLE 15

The procedure was as in Example 14, but no hydrogen was used, the polymerization temperature was 70° C. and the metallocenes used were 1.8 mg of rac-ethylidene(2-methyl-4,6-diisopropyl-1-indenyl)₂ZrCl₂ and 2.5 mg of rac-Me₂Si(2-methyl-4,5-benzoindenyl)₂ZrCl₃. 2.07 kg of polymer powder were obtained. The molding composition prepared by extrusion had the following data:

VI=245 cm³/g; MFI (230/5) 8.5 dg/min; M_{w}=296,500 g/mol; M_{w}/Mₙ=2.9; melting range maximum 145° C., half-intensity width 16.5° C., width at quarter peak height 25.5° C.; crystallization at 109° C.

### EXAMPLE 16

The procedure was as in Example 15, but the metallocenes used were 5.0 mg of dimethylmethylene (9-fluorenyl)-(cyclopentadienyl)ZrCl₂ and 5.0 mg of phenyl(methyl)-methylene (9-fluorenyl) (cyclopentadienyl) ZrCl₂. 1.63 kg of polypropylene were obtained, giving, after extrusion, a molding composition having the following properties:

VI=141 cm³/g; MFI (230/5)=32.5 dg/min; M_{w}=125,500 g/mol; M_{w}/Mₙ=2.5; melting range maximum at 125 and 132° C., half-intensity width 24.5° C., width at quarter peak height 41.5° C.; crystallization at 57° C. and 75° C., half-intensity width 31.5° C.

### EXAMPLE 17

A dry 24 dm³ reactor was flushed with propylene and charged with 9.5 dm³ (S.T.P.) of hydrogen and 12 dm³ of liquid propylene. 35 cm³ of a toluene solution of methyl-aluminoxane (corresponding to 52 mmol of Al, mean degree of oligomerization n=20) were then added. In parallel, 6.5 mg of rac-phenyl(methyl)silyl(2-methyl-4,6-diisopropyl-1-indenyl)₂ZrCl₂ were dissolved in 13.5 cm³ of a toluene solution of methylaluminoxane (20 mmol of Al) and preactivated by standing for 5 minutes.

The solution was then introduced into the reactor, and the mixture was polymerized at 60° C. for 1 hour with continuous addition of 60 g of ethylene. 2.59 kg of random copolymer were obtained. The ethylene content of the copolymer was 2.0% by weight.

VI=503 cm³/g; M_{w}=384,000 g/mol; M_{w}/Mₙ=2.0; melting point=139° C.

A second polymerization was carried out in the same way, but with 5 dm³(S.T.P.) of hydrogen and without addition of ethylene. The metallocene used was 2.5 mg of rac-dimethylsilyl(2-methyl-4-phenyl-1-indenyl)₂ZrCl₂. 1.71 kg of polypropylene were obtained.

VI=524 cm³/g; M_{w}=448,000 g/mol; M_{w}/Mₙ=2.0; melting point=162° C.

1.5 kg of each of the polymers obtained in the two polymerization reactions were stabilized against chemical degradation under extrusion conditions by means of 6 g of pentaerythrityl tetrakis[3-(3,5-di-t-butyl-4-hydroxyphenyl)propionate], extruded in a ZSK 28 twin-screw extruder (Werner und Pfleiderer) and subsequently granulated. The temperatures in the heating zones were 150° C. (feed), 250° C., 270° C., 270° C. and 270° C. (die plate), the material temperature was 285° C. and the extruder screws rotated at 150 rpm.

The molding composition prepared in this way had the following properties:

VI=548 cm³/g; M_{w}=424,000 g/mol; M_{w}/Mₙ=2.5; melting range maximum 158° C., shoulder at 143° C., half-intensity width 19.5° C., width at quarter peak height 35.5° C.; crystallization at 119° C., half-intensity width 11.5° C.

### EXAMPLE 18

The procedure was as in Example 14, but the second metallocene used instead of rac-Me₂Si(2-methyl-4-phenyl-1-indenyl)₂ZrCl₂ was the compound Ph(Me)Si(2-methyl-4-phenyl -1-indenyl)₂ZrCl₂.

1.95 kg of polypropylene were obtained. The extruded molding composition had the following data:

VI=325 cm³/g; MFI (230/5)=3.9 dg/min; melting range maximum 160° C., shoulder at 150° C., half-intensity width 16° C., width at quarter peak height 31° C.; crystallization at 114° C.

### EXAMPLE 19

The procedure was as in Example 14, but the second metallocene used instead of rac-Me₂Si(2-methyl-4-phenyl-1-indenyl)₂ZrCl₂ was the compound rac-Me₂Si (2-methyl-4-(1-naphthyl)-1-indenyl)₂ZrCl₂. 2.55 kg of polypropylene were obtained. The extruded molding composition had the following data:

VI=419 cm³/g; MFI (230/5)=0.9 dg/min; melting range maximum 162° C., shoulder at 150° C., half-intensity width 18° C., width at quarter peak height 30° C.; crystallization at 110° C.

### EXAMPLE 20

The procedure was as in Example 14, but the metallocenes used were 4.0 mg of rac-Me₂Si(2,5,6-trimethyl-1-indenyl)₂-ZrCl₂ and 0.8 mg of rac-Me₂Si(2-methyl-4-(1-naphthyl)-1-indenyl)₂ZrCl₂. 2.30 kg of polypropylene were obtained. The extruded molding composition had the following data:

VI=379 cm³/g; MFI (230/5)=3.0 dg/min; melting peak maximum 161° C., shoulder at 137° C., half-intensity width 22° C., width at quarter peak height 35° C.; crystallization at 112° C.

### EXAMPLE 21

The procedure was as in Example 14, but the metallocenes used were 3.0 mg of rac-Me₂Si(4,5-benzo-1-indenyl)₂ZrCl₂ and 0.8 mg of rac-Me₂Si(2-methyl-4-(1-naphthyl)-1-indenyl)₂ZrCl₂. 2.10 kg of polypropylene were obtained. The extruded molding composition had the following data:

VI=225 cm³/g; MFI (230/5)=23.5 dg/min; melting peak maximum 161° C., shoulder at 140° C., half-intensity width 17° C., width at quarter peak height 32° C.; crystallization at 111° C.

### EXAMPLE 22

The procedure was as in Example 14, but the metallocenes used were 6.0 mg of rac-Me₂Si(4-phenyl-1-indenyl)₂ZrCl₂ and 0.8 mg of rac-Me₂Si(2-methyl-4-phenyl-1-indenyl)₂ZrCl₂. 2.23 kg of polypropylene were obtained. The extruded molding composition had the following data:

VI=220 cm³/g; MFI (230/5)=25 dg/min; melting peak maximum 160° C., shoulder at 149° C., half-intensity width 15° C., width at quarter peak height 30° C.; crystallization at 115° C.

### EXAMPLE 23

The procedure was as in Example 22, but in addition 70 g of ethylene were metered continuously into the reactor during the 1-hour polymerization time. 2.35 kg of ethylene/propylene copolymer were obtained.

VI=190 cm³/g; MFI (230/5)=45 dg/min; melting peak maximum 148° C., shoulder at 132° C., half-intensity width 14° C. The copolymer contained 2.5% by weight of ethylene distributed randomly.

### COMPARATIVE EXAMPLE 1

The procedure was as in Example 1, but the following polymers were used:

Polymer 1: VI=230 cm³/g; MFI (230/5)=15 dg/min; M_{w}=268,000 g/mol; M_{w}/Mₙ=2.0; melting point (maximum) 157° C., half-intensity width of the melting peak 7° C.; width at quarter peak height 10° C.; crystallization point 112° C.

Polymer 2: VI=235 cm³/g; MFI (230/5)=12 dg/min; M_{w}=272,000 g/mol; M_{w}/Mₙ=2.1; melting point (maximum) 154° C., half-intensity width of the melting peak 8° C.; width at quarter peak height 12° C.; crystallization point 109° C., width of crystallization peak (at quarter peak height) 5° C.

### COMPARATIVE EXAMPLE 2

The procedure was as in Example 1, but the following polymers were used:

Polymer 1: VI=260 cm³/g; MFI (230/5)=5 dg/min; M_{w}=295,000 g/mol; M_{w}/Mₙ=2.3; melting point (maximum) 149° C., half-intensity width of the melting peak 6° C.; width at quarter peak height 13° C.; crystallization point 106° C.

Polymer 2: as polymer 2 in Example 1

The non-novel molding composition prepared by extrusion had the following data:

VI=249 cm³/g; MFI (230/5)=8 dg/min; M_{w}=294,500 g/mol; M_{w}/Mₙ=2.6; melting point (maximum) 151° C., half-intensity width of the melting peak 8° C.; width at quarter peak height 12° C.; crystallization point 105° C.

### COMPARATIVE EXAMPLE 3

The procedure was as in Example 1, but the following polymers were used:

Polymer 1: as polymer 1 in Example 1.

Polymer 2: VI=230 cm³/g; MFI (230/5)=14 dg/min; M_{w}=274,500 g/mol; M_{w}/Mₙ=2.3; melting point (melting peak maximum) 135° C., half-intensity width of the melting peak 5.5° C.; width at quarter peak height 14° C.; crystallization point 102° C.

The non-novel molding composition prepared by extrusion had the following data:

VI=240 cm³/g; MFI (230/5)=12 dg/min; M_{w}=287,500 g/mol; M_{w}/Mₙ=2.4; melting point (maximum) 137° C., half-intensity width of the melting peak 5.5° C.; width at quarter peak height 14° C.; crystallization point 102° C., half-intensity width of the crystallization peak 4° C., width at quarter peak height 5° C.

1. A polyolefin molding composition which has a broad, bimodal or multimodal melting range in the DSC spectrum, where the melting range maximum is between 120 and 165° C., the half-intensity width of the melting peak is broader than 10° C. and the width determined at quarter peak height is greater than 15° C.

2. A polyolefin molding composition as claimed in claim 1, wherein the half-intensity width of the crystallization peak is greater than 4° C. and the width of the crystallization peak determined at quarter peak height is greater than 6° C.

3. A polyolefin molding composition as claimed in claim 1, which additionally contains nucleating agents, stabilizers, antioxidants, UV absorbers, light stabilizers, metal deactivators, free-radical scavengers, fillers and reinforcing agents, compatibilizers, plasticizers, lubricants, emulsifiers, pigments, optical brighteners, flameproofing agents, antistatics or blowing agents.

4. A process for the preparation of a polyolefin molding composition as claimed in claim 1, by mixing at least two polyolefins of different melting points, where the melting points of at least two of the polyolefins must differ by at least 5° C., the viscosity indices are greater than VI=10 cm³/g and the molecular weights M_{w} are greater than 5000 g/mol.

5. A process for the preparation of a polyolefin molding composition as claimed in claim 1, by direct polymerization or copolymerization of at least two polyolefins of different melting point, where the melting points must differ by at least 5° C.

6. The process as claimed in claim 5, wherein the olefins have the formula R^{a}CH═CHR^{b}, in which R^{a} and R^{b} are identical or different and are a hydrogen atom or an alkyl radical having 1 to 14 carbon atoms, or R^{a} and R_{b}, together with the atoms connecting them, can form a ring, and are polymerized at a temperature of from −60 to 200° C., and a pressure of from 0.5 to 100 bar, in solution, in suspension or in the gas phase, in the presence of a catalyst, where the catalyst comprises at least two transition-metal components (metallocenes) and an aluminoxane of the formula II 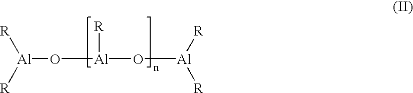
for the linear type and/or of the formula III 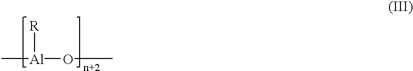
for the cyclic type, where, in the formulae II and III, the radicals R may be identical or different and are a C₁-C₆-alkyl group, a C₁-C₆-fluoroalkyl group, a C₆-C₁₈-aryl group, a C₆-C₁₈-fluoroaryl group or hydrogen, and n is an integer from 0 to 50, and the aluminoxane component may additionally contain a compound of the formula AlR₃,
where the transition-metal component used comprises at least two metallocenes of the formula I: 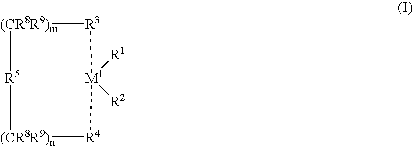
in which
M¹ is Zr, Hf or Ti,
R¹ and R² are identical or different and are a hydrogen atom, a C₁-C₁₀-alkyl group, a C₁-C₁₀-alkoxy group, a C₆-C₁₀-aryl group, a C₆-C₁₀-aryloxy group, a C₂-C₁₀-alkenyl group, a C₇-C₄₀-arylalkyl group, a C₇-C₄₀-alkylaryl group, a C₈-C₄₀-arylalkenyl group or a halogen atom,
R³ and R⁴ are identical or different and are a monocyclic or polycyclic, unsubstituted or substituted hydrocarbon radical which, together with the metal atom M¹, can form a sandwich structure,
R⁵ is 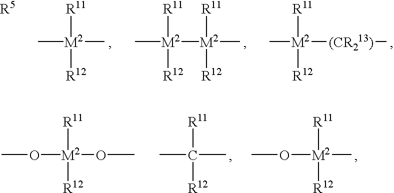
═BR¹¹, ═AlR¹¹, —Ge—, —Sn—, —O—, —S—, ═SO, ═SO₂, ═NR¹¹, ═CO, ═PR¹¹ or ═P(O)R¹¹,
where
R¹¹, R¹² and R¹³ are identical or different and are a hydrogen atom, a halogen atom, a C₁-C₁₀-alkyl group, a C₁-C₁₀-fluoroalkyl group, a C₆-C₁₀-aryl group, a C₆-C₁₀-fluoroaryl group, a C₁-C₁₀-alkoxy group, a C₂-C₁₀-alkenyl group, a C₇-C₄₀-arylalkyl group, a C₈-C₄₀-arylalkenyl group or a C₇-C₄₀-alkylaryl group, or R¹¹ and R¹² or R¹¹ and R¹³, in each case together with the atoms connecting them, form a ring, and
M² is silicon, germanium or tin,
R⁸ and R⁹ are identical or different and are as defined for R¹¹,
m and n are identical or different and are zero, 1 or 2, where m plus n is zero, 1 or 2.

7. The process as claimed in claim 6, wherein
M¹ is Zr, Hf,
R¹ and R² are identical or different and are a hydrogen atom, a C₁-C₃-alkoxy group, a C₁-C₃-alkoxy group, a C₆-C₈-aryl group, a C₆-C₈-aryloxy group, a C₂-C₄-alkenyl group, a C₇-C₁₀-arylalkyl group, a C₇-C₁₂-arylalkyl group, a C₈-C₁₂-arylalkenyl group or chlorine,
R³ and R⁴ are identical or different monocyclic or polycyclic, unsubstituted or substituted hydrocarbon radicals which, together with the metal atom M¹, can form a sandwich structure,
R⁵ is 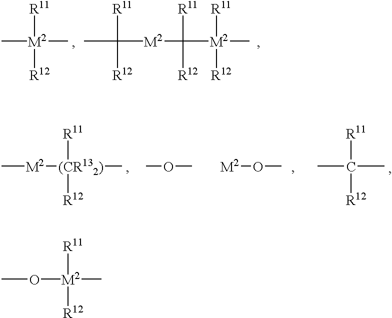
═BR¹¹, ═AlR¹¹, —Ge—, —Sn—, —O—, —S—, ═SO—, ═SO₂, ═NR¹¹, ═CO, ═PR¹¹ or ═P(O)R¹¹, where R¹¹, R¹², and R¹³ are identical or different and are a hydrogen atom, a halogen atom, a C₁-C₄-alkyl group, CF₃ group, a C₆-C₈-aryl group, a pentafluorophenyl group, a C₁-C₄-alkoxy group, a C₂-C₄-alkenyl group, a C₇-C₁₀-arylalkyl group, a C₆-C₁₂-arylalkenyl group or a C₇-C₁₂-alkylaryl group, or R¹¹ and R¹² or R¹¹ and R¹³, in each case together with the atoms connecting them, form a ring,
M² is silicon or germanium,
R⁸ and R⁹ are identical or different and are as defined for R¹¹,
m and n are identical or different and are zero or 1, where m plus n are zero or 1.

8. The process as claimed in claim 6, wherein
M¹ is zirconium or hafnium, R¹ and R² are identical and are methyl or chlorine,
R⁴ and R³ are indenyl, cyclopentadienyl or fluorenyl, where these ligands may carry additional substituents as defined for R¹¹, R¹² and R¹³, where the substituents may be different and, with the atoms connecting them, may also form rings, R⁵ is a 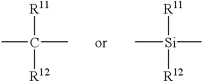
radical, and n plus m are zero or 1.

9. The method of using a molding composition as claimed in claim 1 for the production of moldings.

10. A molding which car be produced from a molding composition as claimed in claim 1.
